(19) United States
(12) Patent Application Publication
(10) Pub. No.: US 2024/0221008 A1
(43) Pub. Date: Jul. 4, 2024

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Jun Uchimura, Tokyo (JP); Yasuyo Kazo, Tokyo (JP)

(73) Assignee: NEC Corporation, Minato-ku, Tokyo (JP)

(21) Appl. No.: 18/684,293

(22) PCT Filed: Aug. 30, 2021
(86) PCT No.: PCT/JP2021/031738

§ 371 Date: Feb. 16, 2024

(51) Int. Cl. G06Q 30/0201; G06Q 30/0207; G06V 40/16; G06V 40/20

(52) U.S. Cl. CPC G06Q 30/0201; G06Q 30/0236; G06V 40/172; G06V 40/20

(57) ABSTRACT

The present invention provides a processing apparatus (10) including: a customer information storage unit (11) that stores customer information of a first customer who has registered customer attribute information and face information and customer information of a second customer who has registered face information without registering customer attribute information; a detection unit (12) that detects the first customer and the second customer in an image captured in a store; a behavior monitoring unit (13) that determines in-store behavior of the first customer and the second customer, and registers the detected in-store behavior in the customer information; and a second customer registration unit (14) that generates, when an unregistered person whose face information is not registered is detected in the image, face information of the unregistered person, and registers the generated face information, as the face information of the second customer, in the customer information.

### TECHNICAL FIELD

The present invention relates to a processing apparatus, processing method, and a program.

### BACKGROUND ART

Patent Document 1 discloses a technique for determining a customer who visits a store, by using a face authentication technique, registering a result of detecting in-store behavior of the determined customer, in association with the customer, and performing a marketing analysis, promotion support, and the like, based on the registered data.

### RELATED DOCUMENT

### Patent Document

Patent Document 1: Japanese Patent Application Publication No. 2008-257488

### DISCLOSURE OF THE INVENTION

### Technical Problem

From a view point of a data analysis, it is desirable to collect more information. However, in a case of the technique described in Patent Document 1, information that can be collected is limited to information on a customer who has registered face information in advance. The technique described in Patent Document 1 has room for improvement in this respect.

An object of the present invention is to enable collection of information of more customers.

### Solution to Problem

According to the present invention, a processing apparatus is provided, the processing apparatus includes:
a customer information storage unit that stores customer information including customer attribute information and face information of a first customer who has registered the customer attribute information and the face information and the face information of a second customer who has registered the face information without registering the customer attribute information:
a detection unit that collates an image captured in a store with the face information, and detects the first customer and the second customer in the image:
a behavior monitoring unit that determines in-store behavior of the first customer and the second customer detected in the image, and registers the determined in-store behavior in the customer information: and
a second customer registration unit that generates, when an unregistered person whose face information is not registered is detected in the image, the face information, based on a face image of the unregistered person included in the image, and registers the generated face information, as the face information of the second customer, in the customer information.

Further, according to the present invention, a processing method is provided, the processing method includes,
by a computer, executing:
storing customer information including customer attribute information and face information of a first customer who has registered the customer attribute information and the face information and the face information of a second customer who has registered the face information without registering the customer attribute information;
a detection step of collating an image captured in a store with the face information, and detecting the first customer and the second customer in the image;
a behavior monitoring step of determining in-store behavior of the first customer and the second customer detected in the image, and registering the determined in-store behavior in the customer information: and
a second customer registration step of generating, when an unregistered person whose face information is not registered is detected in the image, the face information, based on a face image of the unregistered person included in the image, and registering the generated face information, as the face information of the second customer, in the customer information.

Further, according to the present invention, a program is provided, the program causes a computer to function as:
a customer information storage unit that stores customer information including customer attribute information and face information of a first customer who has registered the customer attribute information and the face information and the face information of a second customer who has registered the face information without registering the customer attribute information;
a detection unit that collates an image captured in a store with the face information, and detects the first customer and the second customer in the image;
a behavior monitoring unit that determines in-store behavior of the first customer and the second customer detected in the image, and registers the determined in-store behavior in the customer information: and
a second customer registration unit that generates, when an unregistered person whose face information is not registered is detected in the image, the face information, based on a face image of the unregistered person included in the image, and registers the generated face information, as the face information of the second customer, in the customer information.

### Advantageous Effects of Invention

According to the present invention, information of more customers can be collected.

### BRIEF DESCRIPTION OF THE DRAWINGS

FIG. 1 It is a diagram illustrating one example of a hardware configuration of a processing apparatus according to the present example embodiment.

FIG. 2 It is a diagram illustrating one example of a functional block diagram of the processing apparatus according to the present example embodiment.

FIG. 3 It is a diagram schematically illustrating one example of information processed by the processing apparatus according to the present example embodiment.

FIG. 4 It is a diagram schematically illustrating one example of information processed by the processing apparatus according to the present example embodiment.

FIG. 5 It is a flowchart illustrating one example of a flow of processing by the processing apparatus according to the present example embodiment.

FIG. 6 It is a diagram illustrating one example of a functional block diagram of the processing apparatus according to the present example embodiment.

FIG. 7 It is a flowchart illustrating one example of a flow of processing by the processing apparatus according to the present example embodiment.

FIG. 8 It is a diagram illustrating one example of a functional block diagram of the processing apparatus according to the present example embodiment.

FIG. 9 It is a diagram schematically illustrating one example of information processed by the processing apparatus according to the present example embodiment.

FIG. 10 It is a diagram illustrating one example of a functional block diagram of the processing apparatus according to the present example embodiment.

### DESCRIPTION OF EMBODIMENTS

In the following, example embodiments of the present invention are described with reference to the drawings. Note that, in all the drawings, a similar component is denoted with a similar reference sign, and description thereof is omitted as appropriate.

### First Example Embodiment

### “Outline”

A processing apparatus according to the present example embodiment performs the following processing by using an image captured in a store. First, the processing apparatus detects, within the above-described image, by using a face authentication technique, a customer who has registered face information in advance. Further, the processing apparatus determines in-store behavior of the detected customer, and registers the detected in-store behavior in association with the detected customer. For example, face information od a customer who has performed membership registration and the like is registered in advance.

Further, when an unregistered person whose face information is not registered is detected in the above-described image, the processing apparatus generates face information, based on a face image of the unregistered person included in the above-described image, and registers the generated face information, in association with new customer identification information. By this processing, registration of face information of a customer who has not registered the face information through membership registration and the like is achieved. Hereinafter, the customer is detected in the above-described image through processing using the face authentication technique, and in-store behavior of the customer is registered.

According to the processing apparatus of the present example embodiment, not only information of a customer who has registered face information in advance through membership registration and the like but also information of a customer who has not registered face information in advance through membership registration and the like can be collected.

### “Hardware Configuration”

Next, one example of a hardware configuration of the processing apparatus will be described.

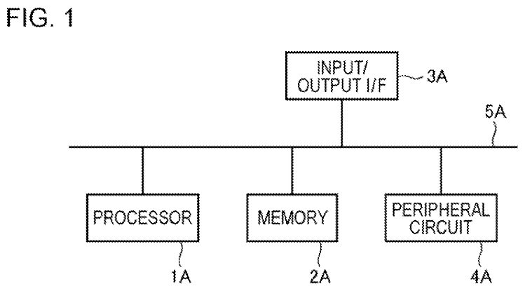

FIG. 1 is a diagram illustrating a hardware configuration example of a processing apparatus 10. Each functional unit included in the processing apparatus 10 is achieved by any combination of hardware and software, mainly including a central processing unit (CPU) of any computer, a memory, a program loaded onto the memory, a storage unit (capable of storing a program downloaded from a storage medium such as a compact disc (CD) or a server on the Internet, as well as a program preliminarily stored since a stage of shipping an apparatus) storing the program, such as a hard disk, and an interface for network connection. Further, it is understood by a person skilled in the art that there are various modification examples for a method and an apparatus for achieving each functional unit.

As illustrated in FIG. 1, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured of a plurality of apparatuses that are physically and/or logically separated, or may be configured of a single apparatus that is physically and logically integrated. When the processing apparatus 10 is configured of a plurality of apparatuses that are physically and/or logically separated, each of the plurality of apparatuses may include the above-described hardware configuration.

The bus 5A is a data transmission path for the processor 1A, the memory 2A, the peripheral circuit 4A, and the input/output interface 3A to transmit and receive data to and from one another. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a key board, a mouse, a microphone, and the like. The output apparatus is, for example, a display; a speaker, a printer, a mailer, and the like. The processor 1A can issue a command to each module, and perform arithmetic operation, based on a result of arithmetic operation by each module.

### “Functional Configuration”

Next, a functional configuration of the processing apparatus 10 will be described. The processing apparatus 10 may be a store server installed for each store, or may be a center server installed for a center that manages a plurality of stores.

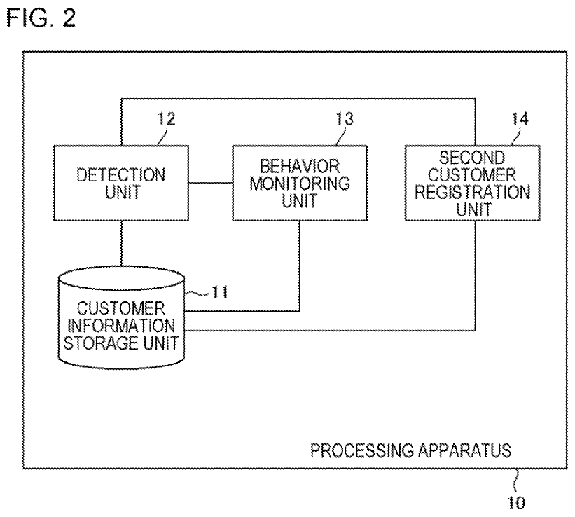

One example of a functional block diagram of the processing apparatus 10 is illustrated in FIG. 2. As illustrated, the processing apparatus 10 includes a customer information storage unit 11, a detection unit 12, a behavior monitoring unit 13, and a second customer registration unit 14.

The customer information storage unit 11 stores customer information of a first customer and a second customer.

The first customer is a customer who has registered customer attribute information and face information. For example, the customer attribute information and the face information of the first customer is registered in the customer information storage unit 11 through membership registration and the like. The customer information of the first customer includes at least the customer attribute information and the face information.

The customer attribute information is information related to a customer, and can include, a name, an address, a phone number, age, an e-mail address, and the like. Note that, the customer attribute information may include another piece of information, and may not include some of the information exemplified herein.

The face information is information generated based on a face image, and the face information may be a feature value of a face, or may be the face image itself.

A customer who desires membership registration and the like operates a terminal apparatus, and transmits his or her own customer attribute information and face image to the processing apparatus 10 via a dedicated application or web page. When the received customer attribute information and the received face image satisfy a predetermined registration condition, the processing apparatus 10 registers, in the customer information storage unit 11, the received customer attribute information and face information generated based on the received face image, in association with customer identification information being newly issued.

The terminal apparatus operated by a customer is a smartphone, a tablet terminal, a mobile phone, a smartwatch, a personal computer, or the like. The registration condition is “combination of an identical name, an identical address, and an identical phone number is not registered”, “a size of a face in the face image is equal to or larger than a criterion”, “a feature value extracted from the face image satisfies a criterion”, and the like.

The second customer is a customer who has registered face information without registering customer attribute information. The face information of the second customer is registered in the customer information storage unit 11 by the second customer registration unit 14 described in the following. The customer information of the second customer includes at least the face information, and does not include the customer attribute information.

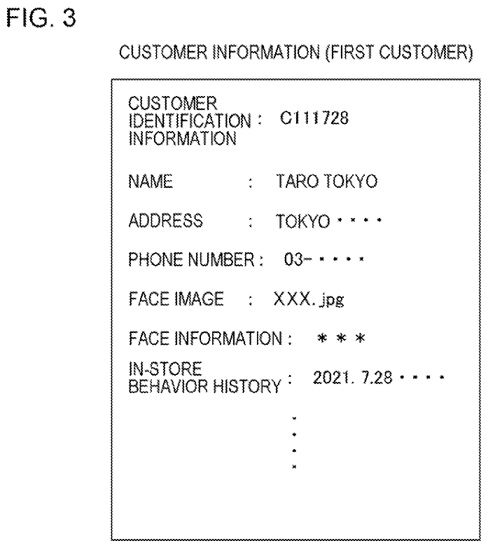

One example of the customer information of the first customer is schematically illustrated in FIG. 3. The illustrated customer information includes customer identification information, a name, an address, a phone number, a face image, the face information, and an in-store behavior history. The in-store behavior history will be described later.

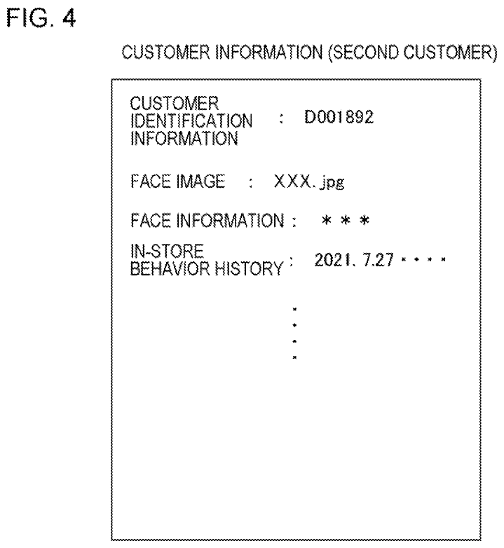

One example of the customer information of the second customer is schematically illustrated in FIG. 4. The illustrated customer information includes customer identification information, a face image, the face information, and an in-store behavior history. The in-store behavior history will be described later.

Comparing FIGS. 3 and 4, the customer information of the first customer and the customer information of the second customer differ in whether the customer attribute information (the name, the address, the phone number, and the like) is included.

Further, the customer information of the first customer and the customer information of the second customer are common in that they both includes the face image and the face information, but are different in means of acquiring the face image and the face information. As described above, the face image and the face information of the first customer are generated based on a face image that a customer himself or herself transmits for membership registration and the like. Further, a certain condition such as “a size of a face in the face image is equal to or larger than a criterion”, “a feature value extracted from the face image satisfies a criterion” can be applied to the face image of the first customer.

On the other hand, the face image and the face information of the second customer is generated based on an image captured in the store (later described in detail). Further, the face image of the second customer is not subject to the above-described condition being applied to the face image of the first customer.

Returning to FIG. 2, the detection unit 12 collates an image (hereinafter, referred to as a “store image”) captured in the store with the face information stored in the customer information storage unit 11, and thereby detects the first customer and the second customer in the store image. The face information collated with the store image includes both the face information of the first customer and the face information of the second customer. The collation is achieved by using any conventional face authentication technique.

The store image is generated by one or a plurality of cameras installed in the store. The camera may capture a moving image, or may capture a still image. Some of the plurality of cameras may capture a moving image, and the other cameras may capture a still image. An installation position of the camera can vary and examples of the installation position include a store entrance, a store exit, sales area of the store, a place of performing accounting processing, and the like, but are not limited thereto.

The behavior monitoring unit 13 determines in-store behavior of the first customer and the second customer who are detected in the store image, and registers the determined in-store behavior of each of the customers in the customer information, in association with the customer.

Determination of the in-store behavior is achieved by using any conventional technique. For example, the behavior monitoring unit 13 may analyze an in-store image and thereby determine a product that a customer has picked up. Further, the behavior monitoring unit 13 may analyze the in-store image and thereby determine a product that a customer has put in a shopping basket. Further, the behavior monitoring unit 13 may determine correspondence between the in-store image capturing a vicinity of a point of sales (POS) register and information registered in the POS register, based on time information and the like, and thereby determine a product that the customer has purchased. Further, the behavior monitoring unit 13 may analyze the in-store image and thereby determine a movement trajectory of a customer within the store. Further, the behavior monitoring unit 13 may analyze the in-store image and thereby determine a point where a customer has stopped in the store. Further, the behavior monitoring unit 13 may analyze the in-store image and thereby determine a product that a customer has tried (sample tasting, watching and listening, test driving, and the like). Furthermore, the behavior monitoring unit 13 may analyze the in-store image capturing the vicinity of the POS register and the in-store image capturing a place of bagging a product to take home and thereby determine whether a customer brings a bag to take a purchased product home. Note that, the in-store behavior to be determined and the means of determination exemplified herein are merely examples, and are not limited thereto.

The behavior monitoring unit 13 registers the in-store behavior of each customers, in association with the customer. An in-store behavior history illustrated in FIGS. 3 and 4 is information indicating the in-store behavior of each customer that the behavior monitoring unit 13 registers in association with the customer. As illustrated, behavior taken in the store may be registered in association with a date and time when the behavior is detected.

Returning to FIG. 2, when an unregistered person whose face information is not registered is detected in the store image, the second customer registration unit 14 generates face information, based on a face image of the unregistered person included in the store image. Then, the second customer registration unit 14 associates the generated face information with newly issued customer identification information, and registers the generated face information in customer information stored in the customer information storage unit 11, as face information of the second customer. The processing of detecting an unregistered person from the store image can be achieved based on a conventional technique. For example, among persons detected from the store image by using a conventional person detection technique, a person whose matching face information is not stored in the customer information storage unit 11 can be detected as an unregistered person.

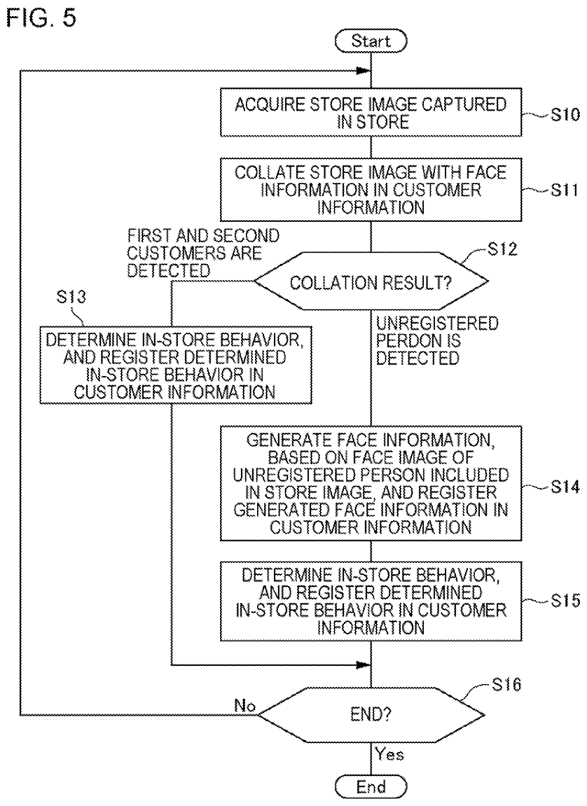

Next, one example of a flow of processing by processing apparatus 10 will be described with reference to a flowchart in FIG. 5.

First, when acquiring a store image generated by a camera installed in a store (S10), the processing apparatus 10 performs processing of collating the store image with face information stored in the customer information storage unit 11 and detecting a first customer and a second customer in the store image (S11).

When the first and second customers are detected in the store image (“FIRST AND SECOND CUSTOMERS ARE DETECTED” in S11), the processing apparatus 10 determines in-store behavior of each customer, and registers information indicating the determined in-store behavior in the customer information, in association with the customer (S13).

On the other hand, when an unregistered person whose face information is not registered is detected (“UNREGISTERED PERSON IS DETECTED” in S11), the processing apparatus 10 performs processing in S14. In S14, the processing apparatus 10 generates face information, based on a face image of the unregistered person included in the store image. Then, the processing apparatus 10 associates the generated face information with newly issued customer identification information and registers the generated face information in the customer information stored in the customer information storage unit 11, as face information of the second customer.

After that, the processing apparatus 10 determines in-store behavior of the second customer whose face information is newly registered, and registers information indicating the determined in-store behavior in the customer information, in association with the customer identification information of the customer (S15).

Note that, when a plurality of persons are detected in the store image, the processing apparatus 10 can execute the processing in S12 to S15 for each of the detected persons.

### Advantageous Effect

When a customer who has registered face information through membership registration and the like in advance is detected in a store image, the processing apparatus 10 according to the present example embodiment can determine in-store behavior of the customer and register the determined in-store behavior, in association with the customer. Further, when an unregistered person who has not registered face information is detected in a store image, the processing apparatus 10 according to the present example embodiment can generate face information of the unregistered person, based on the store image, and can register the generated face information, in association with newly issued customer identification information. Further, thereinafter, the processing apparatus 10 according to the present example embodiment can detect the unregistered person in a store image by using the face information, determine in-store behavior of the unregistered person, and register the determined in-store behavior of the unregistered person, in association with the customer identification information of the unregistered person.

According to the processing apparatus 10 of the present example embodiment, not only information of a customer who has registered face information through membership registration and the like in advance but also information of a customer who has not registered face information through membership registration in advance can be collected. Consequently, information of more customers can be collected.

### Second Example Embodiment

A processing apparatus 10 according to the present example embodiment continues to store registered information of a second customer, specifically, face information and information indicating in-store behavior, as is after a visit to a store when the registration is made.

Specifically, a customer who has not registered face information through membership registration and the like is not registered as a second customer every time the customer visits a store, but once the customer is registered as the second customer, registration status as the second customer is maintained.

Therefore, on a second and subsequent visits to the store, the second customer is detected as a “customer who has registered face information in advance” in a store image. Further, in a case in which a business entity owning a plurality of stores shares registered information of a customer among the plurality of stores, when a customer who is registered as a second customer when visiting a certain store subsequently visits another store, the customer is detected as a “customer who has registered face information in advance” in a store image.

According to the processing apparatus 10 of the present example embodiment, information indicating in-store behavior at each of a plurality of times of visit to the store by a customer who has not registered face information through membership registration and the like in advance can be accumulated together as information of a single customer. This will be described in detail in the following.

A customer information storage unit 11 continues to store customer information of the second customer as is after a visit to the store when registration is made. Therefore, when the second customer visits the store for a second and subsequent times, it becomes status where the customer information of the second customer is already stored in the customer information storage unit 11. Consequently, when the second customer visits the store for the second and subsequent times, the second customer is not detected as an unregistered person.

A detection unit 12 collates a store image with the face information of the second customer by using the above-described customer information of the second customer stored in the customer information storage unit 11, and detects the second customer from the store image. Consequently, the detection unit 12 can detect the second customer who visits the store for the second and subsequent times in the store image.

A behavior monitoring unit 13 registers information indicating in-store behavior by the second customer determined at each of a plurality of times of visit to the store, in association with customer identification information of the second customer. Consequently, the information indicating the in-store behavior by the second customer determined at each of the plurality of times of visit to the store is registered in the customer information, in association with each other (in association with the identical customer identification information).

Other configurations of the processing apparatus 10 according to the present example embodiment are similar to those in the first example embodiment.

According to the processing apparatus 10 of the present example embodiment, an advantageous effect similar to that in the first example embodiment is achieved. Further, according to the processing apparatus 10 of the present example embodiment, information on each of a plurality of times of visit to a store by a customer who has not registered face information through membership registration and the like in advance can be accumulated together as information of a single customer.

### Third Example Embodiment

When a customer registered as a second customer registers customer attribute information and face information through membership registration and the like, and is registered as a first customer, a processing apparatus 10 according to the present example embodiment executes processing of having information (information indicating in-store behavior, and the like) registered while the customer was registered as the second customer be taken over by the customer as it is. This is described in detail in the following.

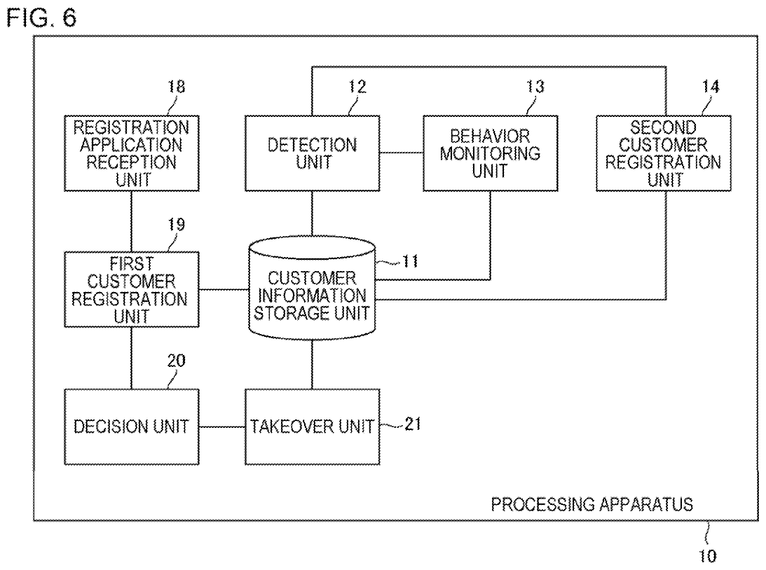

One example of a functional block diagram of a processing apparatus 10 according to the present example embodiment is illustrated in FIG. 6. As illustrated, the processing apparatus 10 according to the present example embodiment differs from that in the first and second example embodiments in that the processing apparatus 10 according to the present example embodiment includes a registration application reception unit 18, a first customer registration unit 19, a decision unit 20, and a takeover unit 21.

The registration application reception unit 18 acquires registration application information including customer attribute information and a face image. For example, a customer who membership registration and the like operates a terminal apparatus, and transmits registration application information including his or her own customer attribute information and face image to the processing apparatus 10 via a dedicated application or web page. The registration application reception unit 18 acquires the registration application information transmitted in this way from the terminal apparatus. The terminal apparatus operated by the customer is a smartphone, a tablet terminal, a mobile phone, a smartwatch, a personal computer, or the like.

The first customer registration unit 19 registers, in customer information, the customer attribute information of an applicant included in the registration application information and face information generated based on the face image included in the registration application information, as customer attribute information and face information of a first customer, in association with newly issued customer identification information.

When the customer attribute information and the face image included in the registration application information satisfy a predetermined registration condition, the first customer registration unit 19 may execute the above-described “processing of registering in the customer information, as the customer attribute information and the face information of the first customer, in association with the newly issued customer identification information”. The registration condition is “combination of an identical name, an identical address, and an identical phone number is not registered”, “a size of a face in the face image is equal to or larger than a criterion”, “a feature value extracted from the face image satisfies a criterion”, and the like.

The decision unit 20 collates the face image included in the registration application information with face information of a second customer included in the customer information stored in a customer information storage unit 11, and decides whether the applicant who has transmitted the registration application information is registered in the customer information as the second customer. When face information of the second customer that matches the face image included in the registration application information is registered, the decision unit 20 decides that the applicant who has transmitted the registration application information is registered in the customer information as the second customer. On the other hand, when face information of the second customer that matches the face image included in the registration application information is not registered, the decision unit 20 decides that the applicant who has transmitted the registration application information is not registered in the customer information as the second customer.

When the applicant who has transmitted the registration application information is registered in the customer information as the second customer, the takeover unit 21 registers information indicating in-store information registered in association with the applicant when the applicant has been registered as the second customer, in association with customer identification information of the applicant who is registered in the customer information as the first customer. By this processing, the information (information indicating in-store behavior, and the like) registered when the customer has been registered in the customer information as the second customer is taken over by the customer even after the customer is registered as the first customer.

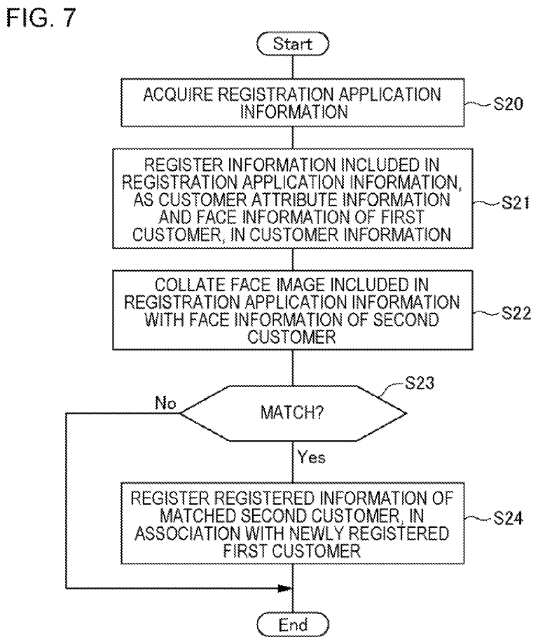

Next, one example of a flow of processing by the processing apparatus 10 is described with reference to a flowchart in FIG. 7.

When acquiring registration application information including customer attribute information and a face image (S20), the processing apparatus 10 registers, in customer information, the customer attribute information of an applicant included in the registration application information and face information generated based on the face image included in the registration application information, as customer attribute information and face information of a first customer, in association with newly issued customer identification information (S21). Note that, when the customer attribute information and the face image included in the registration application information satisfy a predetermined registration condition, the processing apparatus 10 may execute the above-described “processing of registering in the customer information, as the customer attribute information and the face information of the first customer, in association with the newly issued customer identification information”.

Next, the processing apparatus 10 collates the face image included in the registration application information with face information of the second customer included in the customer information stored in the customer information storage unit 11, and decides whether the applicant who has transmitted the registration application information is registered in the customer information as the second customer (S22).

When face information of the second customer that matches the face image included in the registration application information is registered (Yes in S23), processing apparatus 10 decides that the applicant who has transmitted the registration application information is registered in the customer information as the second customer. Then, the processing apparatus 10 registers registered information (information indicating in-store behavior, and the like) of the second customer who matches the face image included in the registration application information, in association with the customer identification information of the first customer newly issued in S21 (S24). Note that, the processing apparatus 10 may delete, according to the processing in S24, the information (information indicating in-store behavior, face information, customer identification information as the second customer, and the like) of the second customer who matches the face image included in the registration application information, from the customer information storage unit 11.

When face information of the second customer that matches the face image included in the registration application information is not registered (No in S23), the processing apparatus 10 decides that the applicant who has transmitted the registration application information is not registered in the customer information as the second customer. In this case, the processing in S24 is not executed.

Other configurations of the processing apparatus 10 according to the present example embodiment are similar to those in the first and second example embodiments.

According to the processing apparatus 10 of the present example embodiment, an advantageous effect similar to that in the first and second example embodiments is achieved. Further, according to the processing apparatus 10 of present example embodiment, when a customer who has been registered as a second customer is registered as a first customer, information (information indicating in-store behavior, and the like) registered when the customer has been registered as the second customer can be taken over by the customer. Consequently, information of more customers can be collected.

### Fourth Example Embodiment

A processing apparatus 10 according to the present example embodiment gives a point to both a first customer and a second customer, based on information indicating in-store behavior stored in a customer information storage unit 11. Further, the processing apparatus 10 permits only the first customer to use the given point. Further, the processing apparatus 10 notifies the second customer of the given point, also notifies the second customer that the point will be enabled to use after a predetermined procedure, and thereby encourages to register as the first customer. This will be described in detail in the following.

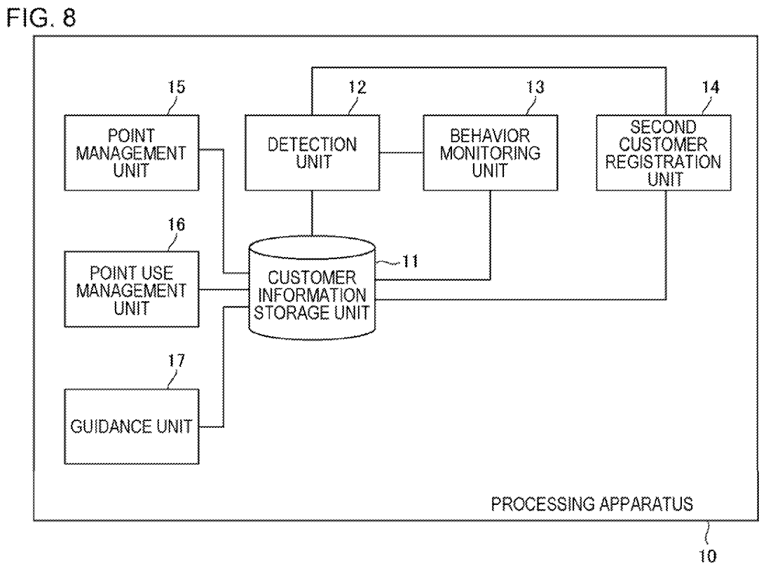

One example of a functional block diagram of the processing apparatus 10 according to the present example embodiment is illustrated in FIG. 8. As illustrated, the processing apparatus 10 according to the present example embodiment differs from that in the first to third example embodiments in that the processing apparatus 10 according to the present example embodiment includes a point management unit 15, a point use management unit 16, and a guidance unit 17. Note that, although it is not illustrated, the processing apparatus 10 according to the present example embodiment may include a registration application reception unit 18, a first customer registration unit 19, a decision unit 20, and a takeover unit 21.

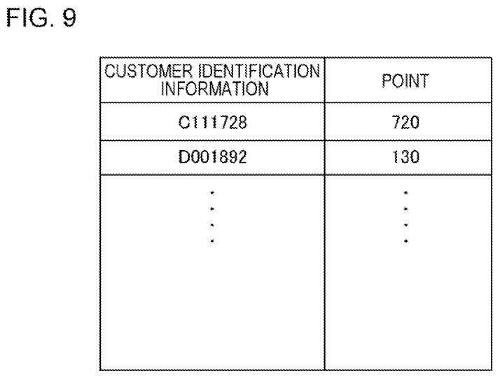

The point management unit 15 manages a point given to a first customer and a second customer, based on in-store behavior registered in customer information. One example of information managed by the point management unit 15 is schematically illustrated in FIG. 9. In the illustrated example, customer identification information and the given point are registered in association with each other.

The point management unit 15 gives a point to each customer, based on a predetermined criterion. For example, the point management unit 15 may give the point, based on the number of visits to a store, time spent in the store, the number of times a customer tries a product, the number of times the customer makes a purchase, a paid amount, the number of times the customer stops in front of a campaign product, the number of times the customer passes by the campaign product, the number of times the customer purchases the campaign product, the number of times the customer brings a bag to take a purchased product home, and the like. The point management unit 15 can give more points to a customer the more times the customer visits to the store, the more times the customer spends in the store, the more times the customer tries a product, the more times the customer makes a purchase, the more a paid amount, the more times the customer stops in front of a campaign product, the more times the customer passes by the campaign product, the more times the customer purchases the campaign product, and the more times the customer brings a bag to take a purchased product home.

The point use management unit 16 permits the first customer to use a point. Note that, the point management unit 16 does not permit the second customer to use the point. There is no limitation on how the point is used. For example, the point may be exchanged for a product, the point may be converted to electronic money, and the point may be used for payment at a store. Such point usage is achieved by using any conventional technique. When the point is used, the point use management unit 16 requires presentation of customer identification information. The point management unit 16 can confirm that a customer who requests to use the point is the first customer, based on the customer identification information.

The guidance unit 17 notifies the second customer of guidance information. The guidance information indicates the point given to the second customer. Further, the guidance information indicates that the point will be usable by performing a predetermined procedure, or that there is a point that will be usable by performing the predetermined procedure.

The predetermined procedure includes at least one of registration of customer attribute information, registration of a face image that satisfies a predetermined condition, and indication of intention to consent that the store uses information indicating in-store behavior registered in association with the second customer. Further, the predetermined procedure may be membership registration and the like.

The guidance unit 17 can notify the second customer of the guidance information via an apparatus installed in the store. The guidance unit 17 collates a customer image generated by a camera (imaging unit) included in the apparatus installed in the store with face information of the second customer included in the customer information, and thereby determines the second customer included in the customer image. Further, the guidance unit 17 causes a display apparatus included in the apparatus to display the guidance information indicating the point given to the determined second customer. Examples of the apparatus installed in the store include a POS register, a digital signage, and the like, but are not limited thereto. Alternatively, the guidance unit 17 may achieve presentation of the guidance information toward the second customer by using a plurality of cameras (imaging units) installed in the store and a plurality of display apparatuses installed in the store. Specifically, the guidance unit 17 detects the second customer from images generated by the plurality of cameras (surveillance cameras and the like), and thereby determines a location of the second customer. Then, the guidance unit 17 causes a display apparatus installed near the determined location of the second customer to display the guidance information.

Note that, in a case in which the processing apparatus 10 according to the present example embodiment includes the configuration of the third example embodiment, when the second customer is registered as the first customer, a point that has been given to the customer while the customer was registered as the second customer may be taken over by the customer after the customer is registered as the first customer.

Other configurations of the processing apparatus 10 according to the present example embodiment are similar to those in the first to third example embodiments.

According to the processing apparatus 10 of the present example embodiment, an advantageous effect similar to that in the first to third example embodiments is achieved. Further, according to the processing apparatus 10 of the present example embodiment, a point can be given to a customer, based on in-store behavior. Therefore, it is possible to encourage a customer to visit the store.

Further, according to the processing apparatus 10 of the present example embodiment, a point can be given not only to information of a customer who has registered face information through membership registration and the like in advance but also to a customer who has not registered face information through membership registration and the like in advance. Therefore, it is also possible to encourage a customer who has not registered face information through membership registration and the like in advance to visit the store.

Further, according to the processing apparatus 10 of the present example embodiment, use of a point by a customer who has not registered face information through membership registration and the like in advance can be restricted after performing a predetermined procedure.

Therefore, it is possible to promote that the predetermined procedure is performed.

### Fifth Example Embodiment

A processing apparatus 10 according to the present example embodiment performs a marketing analysis, promotion support, and the like by analyzing in-store behavior of a first customer and a second customer, registered as customer information. This will be described in detail in the following.

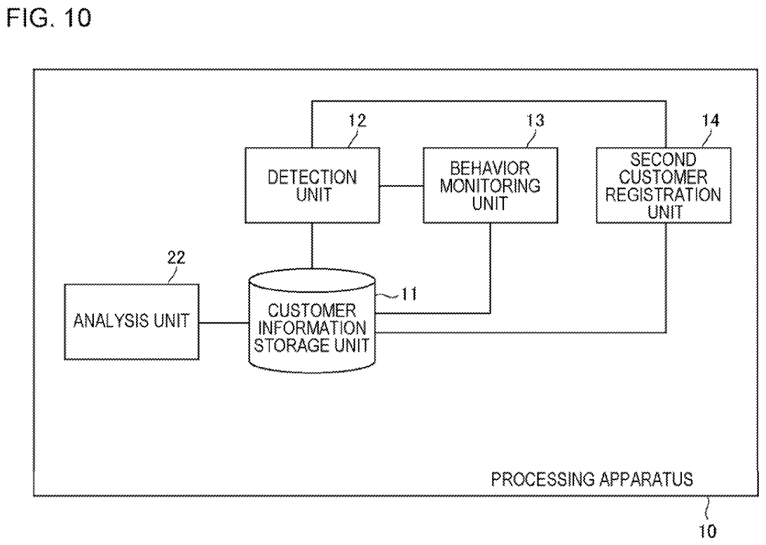

One example of a functional block diagram of the processing apparatus 10 according to the present example embodiment is illustrated in FIG. 10. As illustrated, the processing apparatus 10 according to the present example embodiment differs from that in the first to fourth example embodiments in that the processing apparatus 10 according to the present example embodiment includes an analysis unit 22. Note that, although it is not illustrated, the processing apparatus 10 according to the present example embodiment may include a registration application reception unit 18, a first customer registration unit 19, a decision unit 20, and a takeover unit 21. Further, the processing apparatus 10 according to the present example embodiment may include a point management unit 15, a point use management unit 16, and a guidance unit 17.

The analysis unit 22 analyzes in-store behavior of a first customer and a second customer, registered in customer information.

For example, the analysis unit 22 may compile and statistically process in-store behavior of a plurality of customers, and compute a tendency in the in-store behavior of the customers who visit a store. For example, which customer takes what in-store behavior has visited may be computed by each time and day and each time period. Further, the analysis unit 22 may statistically process the in-store behavior for each of the customers, and compute a tendency in the in-store behavior taken by each of the customers. Further, the analysis unit 22 may decide, based on a result of the computation, a strategy of the store (optimization of ordering, optimization of a product display method, and the like), an action to be taken for each of the customers (product recommendation, advertisement presentation, and the like), and the like.

For example, the analysis unit 22 can determine a customer whose frequency of visiting the store is equal to more than a threshold value as a good customer. Further, the analysis unit 22 can statically process in-store behavior of the good customer, and can determine a tendency in timing of store visit (day of a week, time period, and the like) and a tendency in a product to be purchased. In this case, loss of sales opportunity can be avoided by placing an order in such a way that a product that tends to be purchased by the good customer will not be out of stock at timing when the good customer visits the store.

Further, by deciding which product to recommend to each customer and which advertisement to present to each customer, based on which a tendency in a product to be purchased, sales promotion can be expected.

Herein, a specific example of an analysis by the analysis unit 22 is described. Note that, the specific example described herein is merely an example, and is not limited thereto.

For example, a tendency and the like such as described in the following can be computed by analyzing in-store behavior of each customer.
A probability that a customer A visits a store A on Tuesday is X percent
The customer A stopped in front of a bread display shelf for equal to or longer than t minutes, but did not purchase a product. At that time, a product A is not displayed in the store A.
The product A is already purchased at another store. When the product A is on display, a probability that the product A is purchased is Y percent.

On a basis of the above described tendency and the like, the analysis unit 22 can compute a probability in a case in which the store A orders the product A on Tuesday that the customer A purchases the product A. Further, by performing a similar analysis for another customer, a probability in a case in which the store A orders the product A on Tuesday that the another customer purchases the product A can be computed. Further, the analysis unit 22 can compute, based on results of the computation, that the store A orders the product A on Tuesday, the number of the products A to be ordered, and the like.

Further, the analysis unit 22 can compute a tendency in time period at which the product A is purchased. For example, a Z percent probability that the product A is purchased around noon can be computed. Further, the analysis unit 22 can analyze data of a POS register, and compute a tendency in a product to be purchased together with the product A. For example, an M percent probability that coffee is purchased together with the product A can be computed. Further, the analysis unit 22 can compute, based on in-store behavior that a customer who tends to purchase the product A takes when the product A is not on display (when the product A is out of stock or when the store does not handle the product A), a tendency in customer behavior when the product A is not on display.

Further, on a basis of a result of the computation, analysis unit 22 can compute timing of ordering the product A, the number of the products A to be ordered, and the like.

Other configurations of the processing apparatus 10 according to the present example embodiment are similar to those in the first to fourth example embodiments.

According to the processing apparatus 10 of the present example embodiment, an advantageous effect similar to that in the first to fourth example embodiments is achieved. Further, according to the processing apparatus 10 according to the present example embodiment, a marketing analysis, promotion support, and the like can be performed based on registered in-store behavior of each customer.

### Modification Example

In the above-described example embodiments, the processing apparatus 10 registers a customer as a first customer, in response to an action (registration of customer attribute information and a face image) by the customer. As a modification example, a processing apparatus 10 may register a second customer as a first customer, in response to that customer attribute information of a customer who is registered as the second customer is acquired through another method.

For example, in a case in which customer attribute information of a customer is acquired by a POS register, based on presentation of a membership card or the like, during accounting processing, the processing apparatus 10 acquires the acquired customer attribute information of the customer. Further, the processing apparatus 10 further acquires a face image of the customer acquired (captured) when the membership card is read during the accounting processing. Further, the processing apparatus 10 determines that the customer who performs the accounting processing is a second customer, by collating the face image with face information of the second customer stored in a customer information storage unit 11. Next, the processing apparatus 10 associates information being registered in the customer information storage unit 11 in association with the determined second customer with information being read from the membership card, and re-registers the associated information as information of a first customer. Face information that has been registered as the face information of the second customer may be taken over as it is as face information of the first customer stored in the customer information storage unit 11, or the face image captured when the membership card was read may be registered.

Note that, in the present specification, “acquisition” includes at least one of: “fetching, by an own apparatus, data stored in another apparatus or a storage medium (active acquisition)”, based on a user input or based on a program instruction, for example, receiving by requesting or querying the another apparatus, reading by accessing the another apparatus or the storage medium, and the like: “inputting data that are output from another apparatus to an own apparatus (passive acquisition)”, based on a user input or based on a program instruction, for example, receiving data that are distributed (transmitted, push-notified, or the like), or selecting from among the received data or information and acquiring the selected data or information: and “generating new data by editing data (conversion to text, data rearrangement, partial extraction of data, change in a file format, and the like), and acquiring the new data”.

A part or the entirety of the above-described example embodiments may be described as the following supplementary notes, but is not limited thereto.

1. A processing apparatus including:
a customer information storage unit that stores customer information including customer attribute information and face information of a first customer who has registered the customer attribute information and the face information and the face information of a second customer who has registered the face information without registering the customer attribute information;
a detection unit that collates an image captured in a store with the face information, and detects the first customer and the second customer in the image, a behavior monitoring unit that determines in-store behavior of the first customer and the second customer detected in the image, and registers the determined in-store behavior in the customer information: and
a second customer registration unit that generates, when an unregistered person whose face information is not registered is detected in the image, the face information, based on a face image of the unregistered person included in the image, and registers the generated face information, as the face information of the second customer, in the customer information.

2. The processing apparatus according to supplementary note 1, wherein
the detection unit collates the image with the face information of the second customer, and detects, in the image, the second customer who visits a store for a second or subsequent time, and
the behavior monitoring unit registers in-store behavior of the second customer determined at each of a plurality of times of visit to the store in the customer information, in association with each other.

3. The processing apparatus according to supplementary note 1 or 2, further including:
a point management unit that manages a point given to the first customer and the second customer according to in-store behavior registered in the customer information: and
a point use management unit that permits the first customer to use the point, and does not permit the second customer to use the point.

4. The processing apparatus according to supplementary note 3, further including
a guidance unit that notifies the second customer of guidance information indicating a point given to the second customer and also indicating that the point becomes usable by performing a predetermined procedure.

5. The processing apparatus according to supplementary note 4, wherein
the predetermined procedure includes at least one of
registration of the customer attribute information, registration of the face information satisfying a predetermined condition, and indication of intention to consent that the store uses the registered in-store behavior.

6. The processing apparatus according to supplementary note 4 or 5, wherein
the guidance unit
determines, by collating a customer image generated by an imaging unit installed in a store with the face information included in the customer information, the second customer included in the customer image, and
causes a display apparatus to display the guidance information related to a point given to the determined second customer.

7. The processing apparatus according to any one of supplementary notes 1 to 6, further including:
a registration application reception unit that acquires registration application information including the customer attribute information and a face image;
a first customer registration unit that registers, in the customer information, the customer attribute information of the applicant included in the registration application information and the face information generated based on a face image included in the registration application information, as the customer attribute information and the face information of the first customer;
a decision unit that collates the face image included in the registration application information with the face information of the second customer included in the customer information, and decides whether an applicant who has transmitted the registration application information is registered as the second customer in the customer information: and
a takeover unit that registers, when the applicant is registered as the second customer in the customer information, the in-store behavior registered in association with the applicant while the applicant is registered as the second customer, in association with customer identification information of the applicant who is registered as the first customer in the customer information.

8. The processing apparatus according to any one of supplementary notes 1 to 7, further including
an analysis unit that analyzes in-store behavior of the first customer and the second customer registered in the customer information.

9. A processing method including, by a computer, executing:
storing customer information including customer attribute information and face information of a first customer who has registered the customer attribute information and the face information and the face information of a second customer who has registered the face information without registering the customer attribute information;
a detection step of collating an image captured in a store with the face information, and detecting the first customer and the second customer in the image;
a behavior monitoring step of determining in-store behavior of the first customer and the second customer detected in the image, and registering the determined in-store behavior in the customer information: and
a second customer registration step of generating, when an unregistered person whose face information is not registered is detected in the image, the face information, based on a face image of the unregistered person included in the image, and registering the generated face information, as the face information of the second customer, in the customer information.

10. A program causing a computer to function as:
a customer information storage unit that stores customer information including customer attribute information and face information of a first customer who has registered the customer attribute information and the face information and the face information of a second customer who has registered the face information without registering the customer attribute information;
a detection unit that collates an image captured in a store with the face information, and detects the first customer and the second customer in the image;
a behavior monitoring unit that determines in-store behavior of the first customer and the second customer detected in the image, and registers the determined in-store behavior in the customer information: and
a second customer registration unit that generates, when an unregistered person whose face information is not registered is detected in the image, the face information, based on a face image of the unregistered person included in the image, and registers the generated face information, as the face information of the second customer, in the customer information.

### REFERENCE SIGNS LIST

10 Processing apparatus
11 Customer information storage unit
12 Detection unit
13 Behavior monitoring unit
14 Second customer registration unit
15 Point management unit
16 Point use management unit
17 Guidance unit
18 Registration application reception unit
19 First customer registration unit
20 Decision unit
21 Takeover unit
22 Analysis unit
1A Processor
2A Memory
3A Input/output I/F
4A Peripheral circuit
5A Bus

What is claimed is:

1. A processing apparatus comprising:
at least one memory configured to store one or more instructions; and
at least one processor configured to execute the one or more instructions to:
store customer information including customer attribute information and face information of a first customer who has registered the customer attribute information and the face information and the face information of a second customer who has registered the face information without registering the customer attribute information;
collate an image captured in a store with the face information, and detect the first customer and the second customer in the image,
determine in-store behavior of the first customer and the second customer detected in the image, and register the determined in-store behavior in the customer information; and
generate, when an unregistered person whose face information is not registered is detected in the image, the face information, based on a face image of the unregistered person included in the image, and register the generated face information, as the face information of the second customer, in the customer information.

2. The processing apparatus according to claim 1, wherein the at least one processor is further configured to execute the one or more instructions to
collate the image with the face information of the second customer, and detect, in the image, the second customer who visits a store for a second or subsequent time, and
register in-store behavior of the second customer determined at each of a plurality of times of visit to the store in the customer information, in association with each other.

3. The processing apparatus according to claim 1, wherein the at least one processor is further configured to execute the one or more instructions to
manage a point given to the first customer and the second customer according to in-store behavior registered in the customer information; and
permit the first customer to use the point, and not permit the second customer to use the point.

4. The processing apparatus according to claim 3, wherein the at least one processor is further configured to execute the one or more instructions to
notify the second customer of guidance information indicating a point given to the second customer and also indicating that the point becomes usable by performing a predetermined procedure.

5. The processing apparatus according to claim 4, wherein
the predetermined procedure includes at least one of
registration of the customer attribute information, registration of the face information satisfying a predetermined condition, and indication of intention to consent that the store uses the registered in-store behavior.

6. The processing apparatus according to claim 4, wherein
the at least one processor is further configured to execute the one or more instructions to
determine, by collating a customer image generated by an imaging unit installed in a store with the face information included in the customer information, the second customer included in the customer image, and
cause a display apparatus to display the guidance information related to a point given to the determined second customer.

7. The processing apparatus according to claim 1, wherein the at least one processor is further configured to execute the one or more instructions to
acquire registration application information including the customer attribute information and a face image;
register, in the customer information, the customer attribute information of an applicant included in the registration application information and the face information generated based on a face image included in the registration application information, as the customer attribute information and the face information of the first customer;
collate the face image included in the registration application information with the face information of the second customer included in the customer information, and decide whether the applicant who has transmitted the registration application information is registered as the second customer in the customer information; and
register, when the applicant is registered as the second customer in the customer information, the in-store behavior registered in association with the applicant while the applicant is registered as the second customer, in association with customer identification information of the applicant who is registered as the first customer in the customer information.

8. The processing apparatus according to claim 1, wherein the at least one processor is further configured to execute the one or more instructions to
analyze in-store behavior of the first customer and the second customer registered in the customer information.

9. A processing method comprising,
by a computer, executing:
storing customer information including customer attribute information and face information of a first customer who has registered the customer attribute information and the face information and the face information of a second customer who has registered the face information without registering the customer attribute information;
a detection step of collating an image captured in a store with the face information, and detecting the first customer and the second customer in the image;
a behavior monitoring step of determining in-store behavior of the first customer and the second customer detected in the image, and registering the determined in-store behavior in the customer information; and
a second customer registration step of generating, when an unregistered person whose face information is not registered is detected in the image, the face information, based on a face image of the unregistered person included in the image, and registering the generated face information, as the face information of the second customer, in the customer information.

10. A non-transitory storage medium storing a program causing a computer to:
store customer information including customer attribute information and face information of a first customer who has registered the customer attribute information and the face information and the face information of a second customer who has registered the face information without registering the customer attribute information;
collate an image captured in a store with the face information, and detect the first customer and the second customer in the image;
determine in-store behavior of the first customer and the second customer detected in the image, and register the determined in-store behavior in the customer information; and
generate, when an unregistered person whose face information is not registered is detected in the image, the face information, based on a face image of the unregistered person included in the image, and register the generated face information, as the face information of the second customer, in the customer information.

11. The processing method according to claim 9, wherein the computer
collates the image with the face information of the second customer, and detects, in the image, the second customer who visits a store for a second or subsequent time, and
registers in-store behavior of the second customer determined at each of a plurality of times of visit to the store in the customer information, in association with each other.

12. The processing method according to claim 9, wherein the computer
manages a point given to the first customer and the second customer according to in-store behavior registered in the customer information; and
permits the first customer to use the point, and does not permit the second customer to use the point.

13. The processing method according to claim 12, wherein the computer
notifies the second customer of guidance information indicating a point given to the second customer and also indicating that the point becomes usable by performing a predetermined procedure.

14. The processing method according to claim 13, wherein
the predetermined procedure includes at least one of
registration of the customer attribute information, registration of the face information satisfying a predetermined condition, and indication of intention to consent that the store uses the registered in-store behavior.

15. The processing method according to claim 13, wherein
the computer
determines, by collating a customer image generated by an imaging unit installed in a store with the face information included in the customer information, the second customer included in the customer image, and
causes a display apparatus to display the guidance information related to a point given to the determined second customer.

16. The processing method according to claim 9, wherein
the computer
acquires registration application information including the customer attribute information and a face image;
registers, in the customer information, the customer attribute information of an applicant included in the registration application information and the face information generated based on a face image included in the registration application information, as the customer attribute information and the face information of the first customer;
collates the face image included in the registration application information with the face information of the second customer included in the customer information, and decides whether the applicant who has transmitted the registration application information is registered as the second customer in the customer information; and
registers, when the applicant is registered as the second customer in the customer information, the in-store behavior registered in association with the applicant while the applicant is registered as the second customer, in association with customer identification information of the applicant who is registered as the first customer in the customer information.

17. The processing method according to claim 9, wherein the computer
analyzes in-store behavior of the first customer and the second customer registered in the customer information.
